(19) United States
(12) Patent Application Publication
(10) Pub. No.: US 2009/0079913 A1
(43) Pub. Date: Mar. 26, 2009

(54) Optically anisotropic film, polarizing film, producing process thereof, and application use thereof

(75) Inventors: Naoyuki Nishikawa, Kanagawa (JP); Takahiro Kato, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku, Tokyo (JP)

(21) Appl. No.: 11/988,643

(22) PCT Filed: Jul. 14, 2006
(86) PCT No.: PCT/JP2006/314439

§ 371 Date: Jan. 11, 2008

(30) Foreign Application Priority Data
Jul. 15, 2005 (JP) 2005-206652
Sep. 26, 2005 (JP) 2005-278035

(51) Int. Cl. G02F 1/1335; G02B 5/22; B29D 11/00

(52) U.S. Cl. 349/106; 359/885; 250/492.1; 264/1.34

(57) ABSTRACT

A novel optically anisotropic film is disclosed. The film is a film produced by irradiating a polymer film, comprising at least one photoreactive compound and at least one non-liquid crystalline polymer, with a light, thereby inducing or changing an optical anisotropy of the polymer film. A novel process for producing an optically anisotropic film is also disclosed. The process comprises irradiating a polymer film, comprising at least one photoreactive compound and at least one non-liquid crystalline polymer, with a light, thereby controlling an optical anisotropy of the polymer film.

### BACKGROUND OF THE INVENTION

1. Field of the Invention

The present invention relates to an optically anisotropic film, a process useful for producing thereof, as well as a polarizing plate, an image display element and a polarizing film employing the same.

2. Related Art

As an image display device employed in office automation equipments such as word processors, notebook computers, and personal computer monitors, mobile terminals, and television sets, CRTs (Cathode Ray Tubes) have been mainly used so far. Liquid crystal display devices have been used generally instead of CRTs because of reduction in the thickness, weight, and power consumption. Then, various polymer films have become used for such image display devices in various application uses. A liquid crystal device generally comprises a liquid crystal cell and a polarizing plate. The polarizing plate generally comprises a pair of protective films and a polarizing film, which is obtained by dyeing a polarizing film comprising a polyvinyl alcohol film with iodine, conducting stretching, and laminating protective films on both surfaces thereof. Further, for improving the contrast and the view angle of image display devices, optical compensation films and retardation films have been often used. As such an optical compensation film or retardation film, stretched films and films formed by polymerizing liquid crystal molecules aligned in an alignment state, showing anisotropy in the refractive index, have been employed.

In order to further improve the view angle characteristic and the contrast of image display devices, it has been required to control the anisotropy in the refractive index of polymer films, to be employed in image display devices, more accurately. It has been also required to reduce the manufacturing cost for producing such polymer films.

A stretched film suffers from restriction on the stretching direction in producing process, and from difficulty in controlling the anisotropy of refractive index.

Meanwhile, for producing films by polymerizing liquid crystal molecules aligned in an alignment state, the liquid crystal molecules are generally aligned on a surface of an alignment film or substrate. Accordingly, since it is necessary to form an alignment film or substrate in order to produce such a film, it suffers from complexity in producing process. Further, with a view point of finely controlling the anisotropy in refractive index, it suffers from large dependency of the anisotropy in refractive index on property of the alignment film or substrate.

A process for producing a film showing anisotropy in refractive index without any aligning films or substrates has been developed. For example, a process for producing a film showing anisotropy in refractive index comprising irradiating a film, comprising a polymerizable compound having a photo-isomerization group such as azobenzene, or a polymerizable compound and a liquid crystal compound, with a polarized light from an oblique direction, has been known (for example, in Japanese Patent Nos. 3,315,476 and 3,312,063). However, in the film, which is produced according to the process, the photo-isomerization groups or the liquid crystal molecules may not be fixed in an alignment state; and the film, therefore, suffers from instability.

Then, it has been known a process for producing a film showing anisotropy in refractive index comprising irradiating a film-like molded product of a mixture comprising a liquid crystalline monomer having a crosslinking group and a photoreactive monomer (optically aligning monomer) with a polarized light, thereby optically aligning the liquid crystal monomer molecules, and irradiating it again with a light, thereby crosslinking liquid crystal monomer molecules and fixing them in an alignment state (for example, in JPW No. 2005-517605 (the term “JPW” as used herein means an “Japanese translation of PCT international application (Tokkyo Kohyou)”)). However, according to the process, molecules of the liquid crystal monomer may be partially polymerized when being irradiated with a polarized light; and, as a result, the obtained films sometimes show undesirable optical characteristic. In order to solve such a problem, it may be proposed that the polymerization reaction of the photoreactive monomer is carried out under a condition capable of suppressing the polymerizing reaction while being irradiated with a polarized light. However, carrying out the polymerization under such a condition may contribute to complicating the process, and give insufficiently cross-linked and fragile films.

For solving the foregoing problems, it has been reported a process for producing an optical film by preparing a film-like molded product of a mixture of a liquid crystal polymer and a photoreactive compound, irradiating the film-like molded product with a light to change the structures of molecules of the photoreactive compound, heating the film-like molded product to a temperature higher than the temperature where the liquid crystal polymer shows the liquid crystal state, thereby aligning molecules of the liquid crystal polymer, then cooling the film-like molded product to a temperature lower than the temperature where the polymer shows the liquid crystal state, and fixing the state of alignment (for example, in JPA No. 2005-62765, the term “JPA” as used herein means an “unexamined published Japanese patent application (Kohkai Tokkyo Kohou)”). However, the optical film prepared according to the process described above surfers from, for example, heat-instability, and decrease or disappearance of the anisotropy in refractive index when being heated to a temperature higher than the temperature where polymer shows the liquid crystal state.

A polarizing plate used for the liquid crystal display device (LCD) or the like is selected from iodine polarizing plates comprising a linear polarizing film formed by monoaxially stretching polyvinyl alcohol (PVA) films adsorbing an iodine complex, and dye polarizing plates comprising a linear polarizing film by monoaxially stretching polyvinyl alcohol (PVA) films adsorbing a dichroic dye. The iodine polarized plate is excellent in the degree of polarization and the transmittance and has been adopted in most of high contrast LCDs such as for notebook computers, LCD monitors, liquid crystal television sets or the like. On the other hand, the dye polarizing plate has high weather proofness although poor in view of the polarization degree compared with the iodine polarizing plate, and has been often adopted in outdoor use such as for car mounted LCDs or polarizing sunglass.

However, since the iodine polarizing plate or the dye polarizing plate has two protective films such as triacetyl cellulose (TAC) films for protecting the liner polarizing film since the monoaxially stretched PVA tends to be torn. Therefore, the thickness is extremely large, and an expensive non-retardation or less-retardation film has to be used in principle as a protective film to result in a problem of increasing the cost. Further, such polarizing plates generally surfers from difficulties in being processed by pattern forming or specific-shape forming such as forming into a shape having a curved surface.

In addition, a polarizing element or plate formed using a combination of an photo-alignment layer and a dichroic dye has been proposed (JPA Nos. hei 7-261024 and hei 9-197125). The polarizing element and plate can be formed into a complicated pattern or a shape of a curved surface by patterning the photo-alignment by irradiating it with a light.

However, since it has an expensive photo-alignment layer in addition to the polarizing layer, it surfers from increase of its production cost. Further, the preparation step includes, for example, a coating step for a photo-alignment layer, a photo-alignment step by light-irradiation, a coating step for a dichroic dye, and an aligning step for the dichroic dye and, since this is extremely long and complicated, it results in a problem of increasing the manufacturing cost. Further, only dichroic dyes capable of being aligned on a surface of a photo-alignment layer can be employed for producing such polarizing elements or plates.

Further, it has also been proposed a polarizing element obtained by forming a liquid crystal layer comprising a curable liquid crystal and a dichroic dye on a support provided with an alignment layer and curing the liquid crystal layer (JPA No. 2001-330726). However, also in the polarizing element produced according to the process described above, since an expensive curable liquid crystal is employed and the manufacturing step thereof is complicated, it cannot say that the problem of increasing the production cost is improved sufficiently. Further, since the liquid crystal alignment is employed for the anisotropic alignment of the dichroic dye, this results in a problem of scattering of light due to disturbance and the fluctuation in the alignment of the liquid crystal.

### SUMMARY OF THE INVENTION

One object of the present invention is to provide an optically anisotropic film excellent in the adaptability to production and improved in preservation stability, and a process useful for producing it. Another object of the invention is to provide a polarizing plate or an image display element employing the optically anisotropic film.

Another object of the invention is to provide a polarizing film, even having an extremely fine polarization pattern, capable of being produced with a low cost according to a process, comprising a coating step and not requiring any stretching steps, any expensive protective film or any alignment layers, and to provide a process for producing it.

In one aspect, the invention provides an optically anisotropic film produced by irradiating a polymer film, comprising at least one photoreactive compound and at least one non-liquid crystalline polymer, with a light, thereby inducing or changing an optical anisotropy of the polymer film.

As embodiments of the invention, there are provided the optically anisotropic film wherein the photoreactive compound has at least one polymerizable group; the optically anisotropic film wherein the photoreactive compound is a liquid crystalline compound; the optically anisotropic film wherein the photoreactive compound is a cinnamic acid derivative or a coumarin derivative; the optically anisotropic film wherein the non-liquid crystalline polymer is selected from the group consisting of polyacrylates, polymethacrylates, polyvinyl alcohols, polycarbonates, polysulfones, cellulose based polymers, polyolefins and copolymers thereof; the optically anisotropic film wherein the polymer film is a monoaxially or biaxially oriented film; the optically anisotropic film further comprising an optically anisotropic layer containing a polymer of a liquid crystalline composition comprising at least one liquid crystalline compound; and the optically anisotropic film used as an optical compensation film.

In another aspect, the invention provides a polarizing plate comprising a linear polarizing film and the optically anisotropic film of the invention; and an image-displaying element comprising the optically anisotropic or the polarizing plate.

In another aspect, the invention provides a process for producing an optically anisotropic film comprising irradiating a polymer film, comprising at least one photoreactive compound and at least one non-liquid crystalline polymer, with a light, thereby controlling an optical anisotropy of the polymer film.

The process may further comprise stretching the polymer film monoaxially or biaxially before the irradiating.

The irradiating may be carried out by irradiating the polymer film with a light coming from a direction inclined by θ° (0<θ) relative to the normal direction of the polymer film.

The irradiation light may be a linearly polarized light and/or an ultraviolet light.

In another aspect, the invention provides a polarizing film produced by irradiating a polymer film, comprising at least one photoreactive compound exhibiting an absorption in a wavelength region of from 400 nm to 800 nm and at least one non-liquid crystalline polymer, with a polarized light, thereby inducing a polarization ability of the polymer film; and a process for producing a polarizing film comprising irradiating a polymer film, comprising at least one photoreactive compound and at least one non-liquid crystalline polymer, with a linearly polarized light, thereby controlling a polarization ability of the polymer film.

The photoreactive compound may be selected from dichroic compounds.

The photoreactive compound may be selected from photodegradable compounds.

The polarizing plate of the invention may be used as a color filter.

According to the invention, since the light is irradiated to a photoreactive composition comprising a photoreactive compound and a non-liquid crystalline polymer thereby inducing or changing the optical anisotropy of the composition, and controlling or adjusting the same, it does not require an aligning step for the liquid crystal. The known process, using a liquid crystalline monomer or a liquid crystalline polymer, requires an aligning step for the liquid crystal; and, thus, the process of the invention differs from the known process in this viewpoint, and has an effect of simplifying the step and reducing the cost. Further, the process of the invention can provide an optically anisotropic film having a high stability. Further, since various optical characteristics, such as retardation and wavelength-dispersibility of retardation, of the polymer film employed in the invention can be adjusted within the predetermined range by using a light, it is possible to provide an optically anisotropic film having high quality which is useful as an optical compensation film, or for being employed in a polarizing plate or in an image display device. The invention can also provide a polarizing element having an extremely fine polarization pattern at a low cost.

### BRIEF DESCRIPTION OF THE DRAWINGS

FIG. 1 is a graph showing the wavelength dependency of retardation of an optically anisotropic film of Examples 11 and 12.

FIG. 2 is a view showing the result of observation by polarization microscope for orthogonal positions of an optically anisotropic film in Example 14.

FIG. 3 is a view showing the result of observation by polarization microscope for extinction positions of an optically anisotropic film in Example 14.

### PREFERRED EMBODIMENT OF THE INVENTION

The present invention will be described in detail. It is to be understood, in this description, that the term “ . . . to . . . ” is used as meaning a range inclusive of the lower and upper values disposed therebefore and thereafter.

In the description, Re(λ) represents an in-plane retardation at a wavelength λ. Re(λ) can be measured for an outgoing light at a wavelength of λ nm according to a Senarmer method, which is described by Hiroshi Awaya “Introduction to Polarization Microscope for Polymer Material”, from Agune Technical Center (2001). Alternatively, it can be measured for an outgoing light at a wavelength of λ nm in the normal direction to the film by using KOBRA 31PRN or KOBRA WR (each manufactured by Oji Instruments Co.).

### [Optically Anisotropic Film]

The invention relates to an optically anisotropic film obtained by irradiating a polymer film, comprising at least one photoreactive compound and at least one non-liquid crystalline polymer, with a light, thereby inducing or changing the optical anisotropy of the polymer film. Irradiated with a light, the reaction of the photoreactive compound is carried out, thereby inducing or changing the optical anisotropy. As a result, the retardation of the polymer film can be adjusted within the predetermined range, and the wavelength dispersibility can also be adjusted within the predetermined range.

The term “inducing optical anisotropy” means to change at least a portion of an optically isotropic film into an optically anisotropic portion. And the term “changing optical anisotropy” is used for various embodiments, for example, increasing or decreasing optical anisotropy of a polymer film, changing in direction of the in-plane slow axis of a polymer film.

Next, various materials which can be used for producing the optically anisotropic film of the invention will be described in detail.

### [Photoreactive Compound]

In the invention, a photoreactive compound is a compound capable of reacting when being irradiated with a light. The photoreactive compound may be selected from the compounds capable of at least one photoreaction such as photo-isomerization, photo-cyclization dimerization, photodegradation and combinations thereof when being irradiated with a light. The photoreactive compound is preferably selected from the compounds capable of photo-isomerization or photo-cyclization dimerization by light irradiation, and it is more preferably selected from the compounds capable of photo-cyclization dimerization. The photoreactive compound may be either a low molecular weight compound or high molecular weight compound and in a case of the low molecular compound, it is preferred that the compound has a crystallinity. Further, it is preferred that the photoreactive compound has at least one polymerizable group and, more preferably, has a plurality of polymerizable groups.

Examples of the compound capable of photo-isomerization include compounds capable of stereo-isomerization or structural isomerization when being irradiated with a light. Specific examples of the photo-isomerization compound includes azobenzene compounds such as those described in Langmuir, vol. 4, p. 1214 (1988), K. Ichimura et al., Langmuir, vol. 8, p. 1007 (1992), K. Aoki et al., Langmuir, vol. 8, p. 2601 (1992), Y. Suzuki et al., Appl. Phys. Lett., vol. 63, No. 4, p. 449 (1993), K. Ichimura et al., Langmuir, vol. 9, p. 3298 (1993), N. Ishizuki, and Langmuir, vol. 9, p. 857 (1993), N. Ishizuki; hydrazono-β-keto ester compounds such as those described in Liquid Crystals, vol. 13, No. 2, p. 189 (1993) S. Yamamura et al.; stilbene compounds such as those described in KOBUNSHI RONBUNSHU (Japanese Journal of Polymer Science and Technology) vol. 47, No. 10 p. 771 (1990) K. Ichimura et al.; and spiro pyran compounds such as those described in Chemistry Letters, p. 1063 (1992), K. Ichimura et al., and Thin Solid Films, vol. 235, p. 101 (1993), K. Ichimura et al. Among them, photo-isomerization compounds containing double bond structure of C═C or N═N are preferred and azobenzene compounds containing double bond structure of N═N are particularly preferred.

Examples of the compound capable of photo-cyclization dimerization include compounds that can undergo addition reaction of intermolecular groups to cyclize when being irradiated with a light. Specific examples of the photo-cyclization dimerization compounds include succinic acid derivatives such as those described in J. Appl. Phys., vol. 31, No. 7, p. 2155 (1992), M. Schadt et al.; cumarine derivatives such as those described in Nature, vol. 381, p. 212 (1996), M. Schadt et al.; chalcone derivatives such as those described in Pre-Text of Liquid Crystal Discussion Meeting, 2AB03 (1997), Toshihiro Ogawa, et. al.; and benzophenone derivatives such as those described in SID Int. Symposium Digest, P-53 (1997), Y. K. Jang et al. Among them, succinic acid derivatives and cumarine derivatives are preferred and succinic acid derivatives are particularly preferred. For the succinic acid derivatives, succinic acid derivatives having biphenyl groups are preferred and, succinic acid biphenyl derivatives and phenyl succinic acid phenyl derivatives are particularly preferred.

The succinic acid derivatives represented by the following formula C-1 are preferably used in the invention as a photoreactive compound.

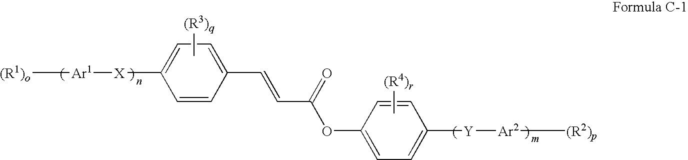

In the formula, each of Ar¹ and Ar² represents a C₆₋₁₀ aromatic ring residue or a C₅₋₁₀ heterocyclic ring residue which may have a substituent. Each of Ar¹ and Ar² is, preferably, a substituted or not-substituted benzene ring residue, naphthalene ring residue, furan ring residue, or thiophene ring, residue and the substituted or not-substituted benzene ring residue is particularly preferred. Each of X and Y represents a single bond or a bivalent linking group. Each of X and Y is, preferably, a single bond, or a bivalent linking group selected from the group consisting of C═C, C≡C, COO, OCO, CONH, NHCO, OCOO, OCONH, and NHCOO and, more preferably, the single bond. Each of R¹ and R² is a substituent for Ar¹ and Ar². Each of R¹ and R² is, preferably, an alkyl group, alkoxyl group, alkoxycarbonyl group, alkoxycarbonyloxy group, alkanoyl group, alkanoyloxy group, cyano group, nitro group, or a halogen group, and, particularly preferably, alkoxyl group, alkoxycarbonyl group, alkoxycarbonyloxy group, alkanoyloxy group, or cyano group. Further, it is preferred that R¹ and R² have a polymerizable group. Examples of preferred polymerizable groups can include, for example, acryloyloxy group, methacryloyloxy group, vinyl group, vinyloxy group, glycidyl group, and oxetane group. Further, each of R¹ and R² may be bond to a main polymer chain to form a side chain of the polymer. Each of R³ and R⁴ represents a substituent for the benzene ring and can include, for example, a C₁₋₆ alkyl group, a C₁₋₆ alkoxyl group, or halogen group. Each of “n” and “m” represents independently an integer of 0 to 3. It is, preferably, 0 or 1 and it is particularly preferred that at least one of “n” and “m” is 1. In the formula, “o” and “p” each represents independently an integer of 0 to 4. Each of “o” and “p” preferably represents 0 to 2 and it is particularly preferred that each of “o” and “p” represents 0 to 2 and “o+p” represents 1 to 3. Further, each of “q” and “r” represents an integer of 0 to 4 and, preferably, 0 or 1.

The cumarine derivatives represented by the following formula C-2 are preferably used in the invention as a photoreactive compound.

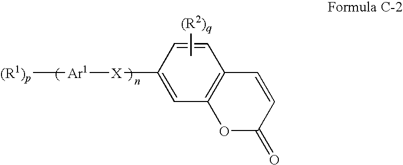

In the formula C-2, each of Ar¹, R¹, R², X, n, p and q has the same meanings as that in the formula C-1.

Examples of the compound capable of photodegradation, which can be used in the invention as a photoreactive compound, include photodegradable polyimide described in Pre-Text of 22ₜₕ Liquid Crystal Discussion Meeting, p 1672, A17 (1996).

Further, the photodegradable compound, which can be used in the invention as a photoreactive compound, may also be selected from dyes, that is, may be selected from compounds having an absorption in a visible light wavelength region of from 400 nm to 800 nm. Among them, it is preferably selected from dichroic dyes absorbing light coming in the direction along with the long axis of molecule at a certain degree and absorbing light coming in the direction along with the short axis of molecule at a different degree. Particularly, the photodegradable dichroic dye is preferably employed for the production of a polarizing film of the invention. Examples of the photodegradable dichroic dye, which can be used in the invention as a photoreactive compound, include tolan derivatives represented by the following formula C-3.

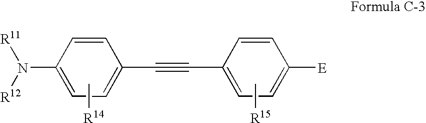

In the formula, each of R¹¹ and R¹² represents a hydrogen atom or an alkyl group and the alkyl group may have a substituent. Each of R¹⁴ and R¹⁵ represents a hydrogen atom, lower (C₁₋₆) alkyl group or lower (C₁₋₆) alkoxy group. In the formula, E represents an ethylene group having a plurality of electron attracting groups.

In the formula C-3, each of R¹¹ and R¹² represents, preferably, a C₁₋₂₀ alkyl group which may be substituted and, more preferably, a C₁₋₁₀ alkyl group which may be substituted. R¹¹ or R¹² may have a substituent, and preferred examples of the substituent include polymerizable groups. In the description, the term “polymerizable group” means a functional group employed in polymerization processes described, for example, in “Polymer Chemistry” edited by Shunsuke Murase (published from Kyoritsu Shuppan in 1966), Chapters 2 to 5. Examples of the polymerizable group include, for example, a multiple bond (constituent atoms may either be carbon atom or non-carbon atom), heterocyclic small-membered ring such as oxyrane or azilidine, combination of different functional groups such as isocyanate and amine added thereto. As described in the study report of R. A. M. Hikmet, et al. [Macromolecules, vol. 25, p 4194 (1992)) and [Polymer, vol. 34, No. 8, p 1763 (1993)], and study reports of D. J. Broer, et al. [Macromolecules, vol. 26, p 1244 (1993)], double bond, that is, acryloyloxy group, mechacryloyloxy group, vinyloxy group, and epoxy group can be mentioned as preferred examples and the acryloyloxy group is particularly preferred.

In the formula C-3, each of R¹⁴ and R¹⁵ is preferably, a hydrogen atom, methyl group, or methoxy group.

In the formula C-3, a plurality of electron attracting groups represented by E may be identical or different with each other. Preferred examples of the electron attracting groups include, for example, a cyano group, alkoxyoxycarbonyl group, (more preferably, alkoxyoxycarbonyl group having 2 to 12 carbon atoms in the alkyl moiety).

As mentioned above, the photoreactive compound may be selected from homopolymers and copolymers. The weigh-average molecular weight thereof is not to be limited to a certain range, and is preferably from 1,000 to 500,000, is more preferably from 5,000 to 300,000, and is much more preferably from 7,000 to 100,000. And the photoreactive compound may be selected from copolymers comprising at least one repeat unit derived from a photoreactive compound and at least one repeat unit derived from a monomer other than a photoreactive compound. The copolymerization ratio (molar ratio) thereof is not to be limited to a certain range, and the molar ratio of the unit derived from a photoreactive compound is preferably from 0.1 to 99.9, is more preferably from 1 to 99, and is much more preferably from 10 to 90 with respect to the total molar ratio, i.e. 100, of all repeat units included in the copolymer.

Specific examples of the photoreactive compounds usable in the invention include, however are not limited to, those shown below. Among the formulae of the specific examples shown below, in the formulae of copolymers, l, m and n respectively represent a copolymerization ratio (molar ratio) of each monomer, and in the formulae of homopolymers, n represents an average polymerization degree of each monomer.

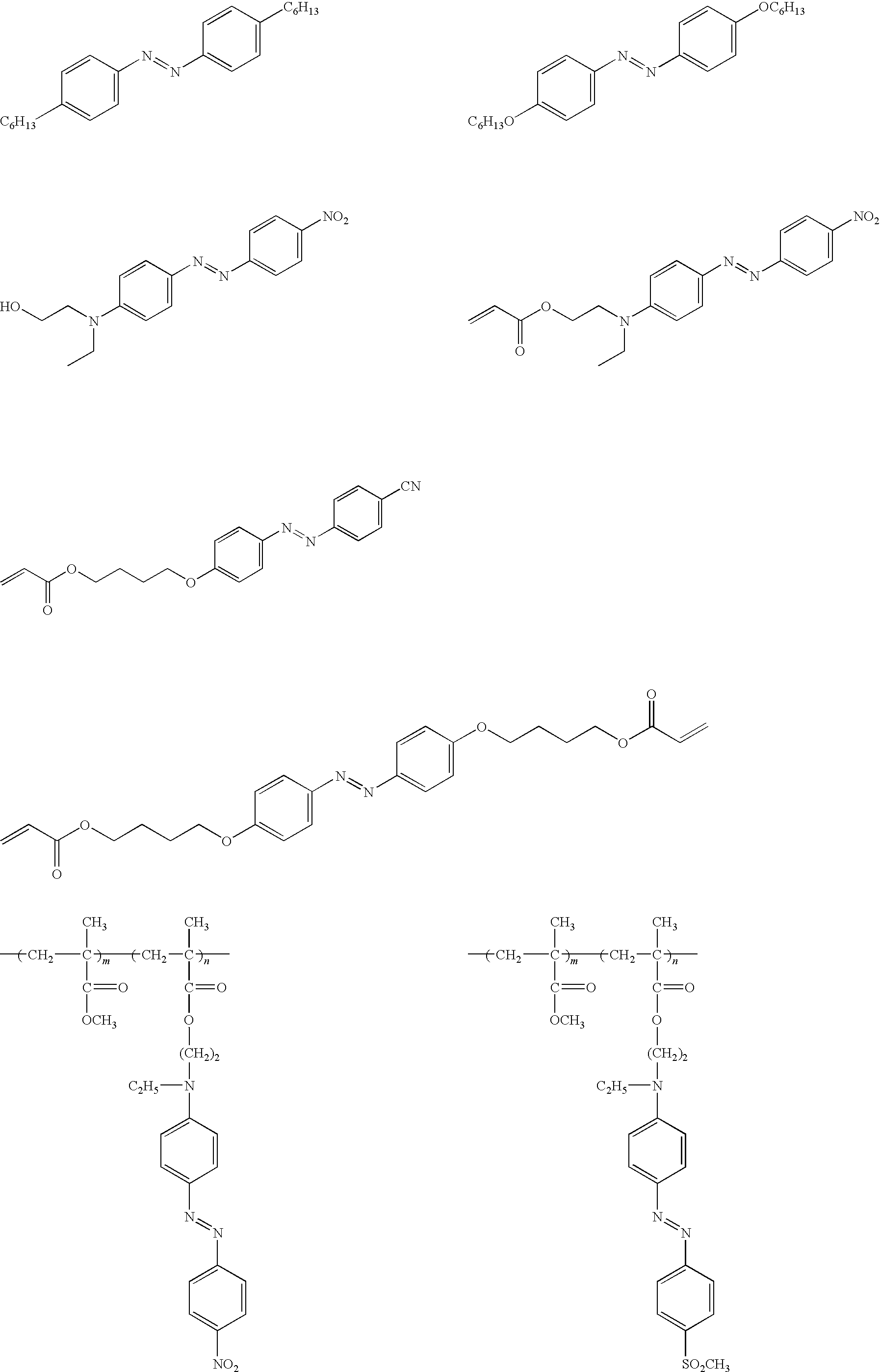

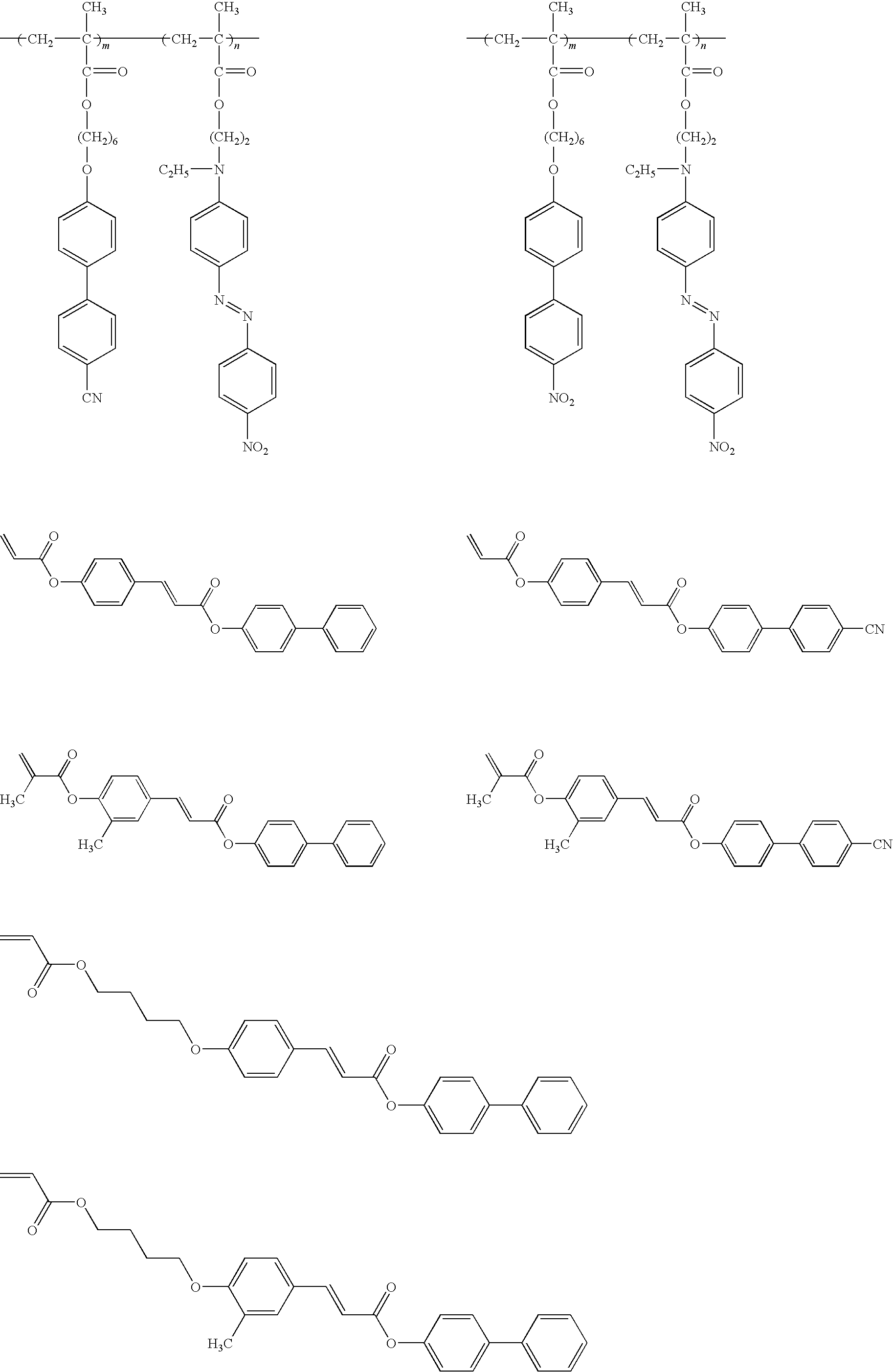

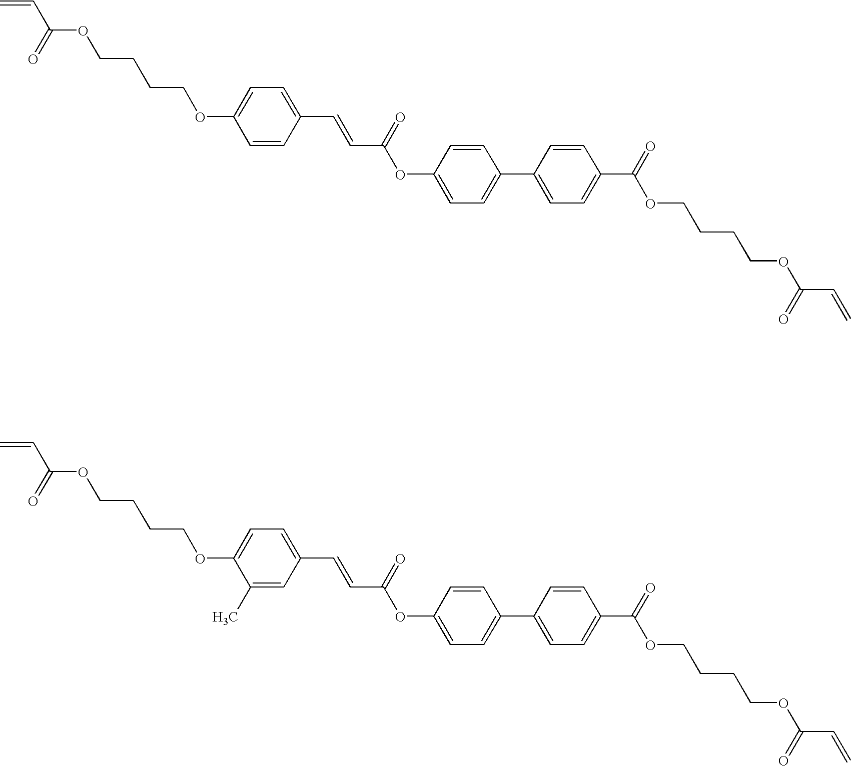

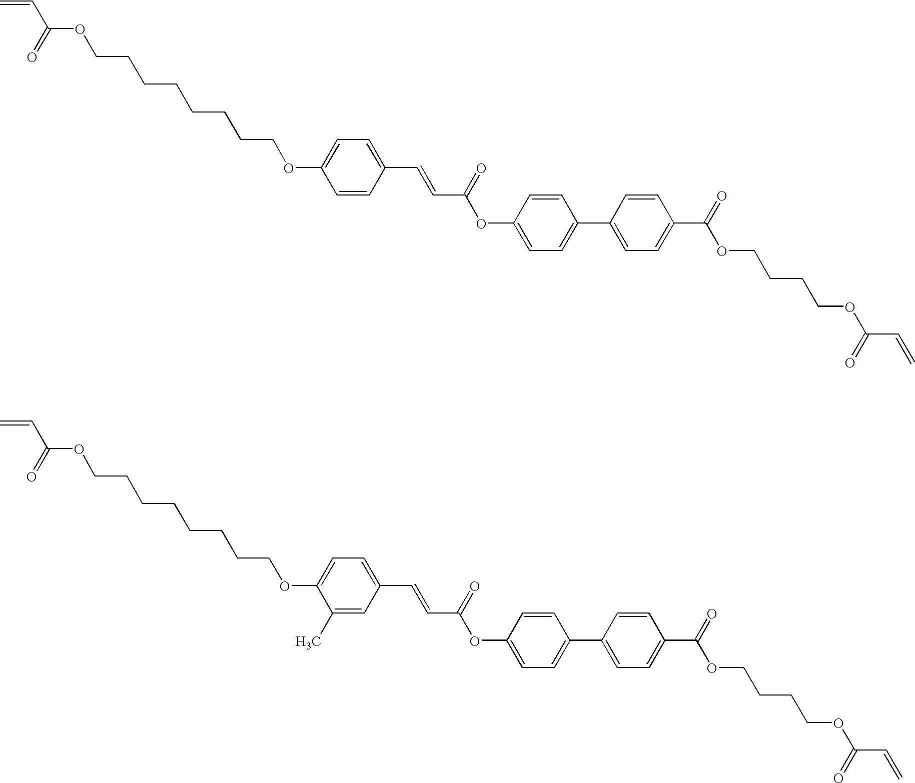

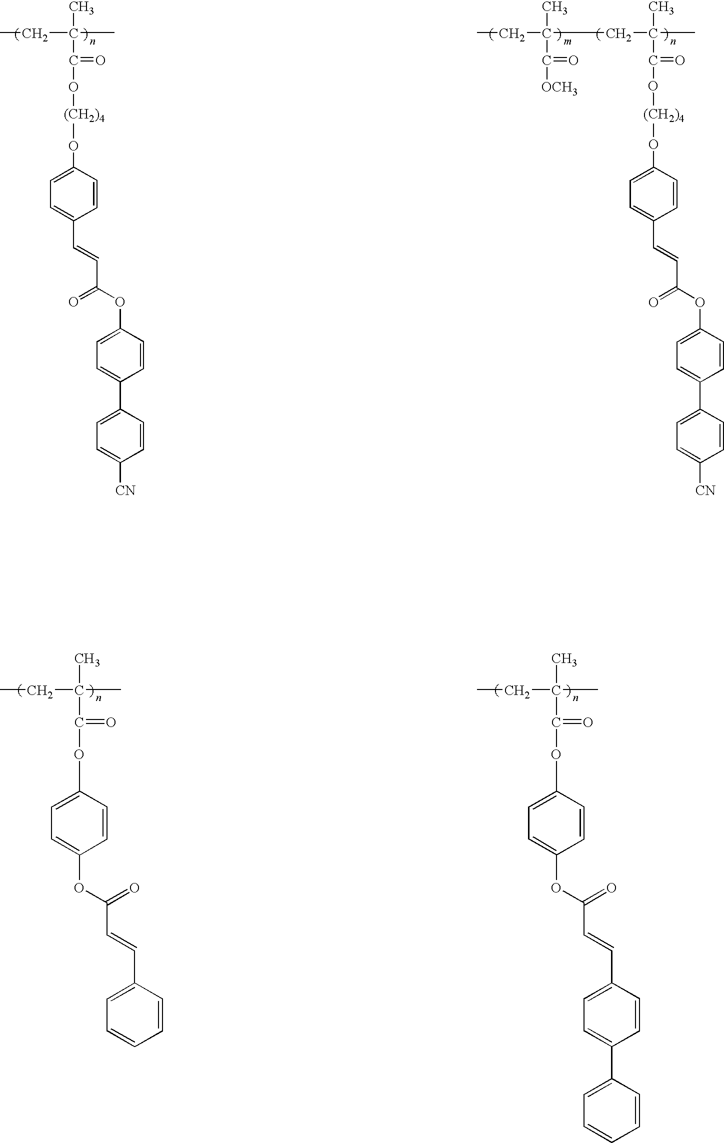

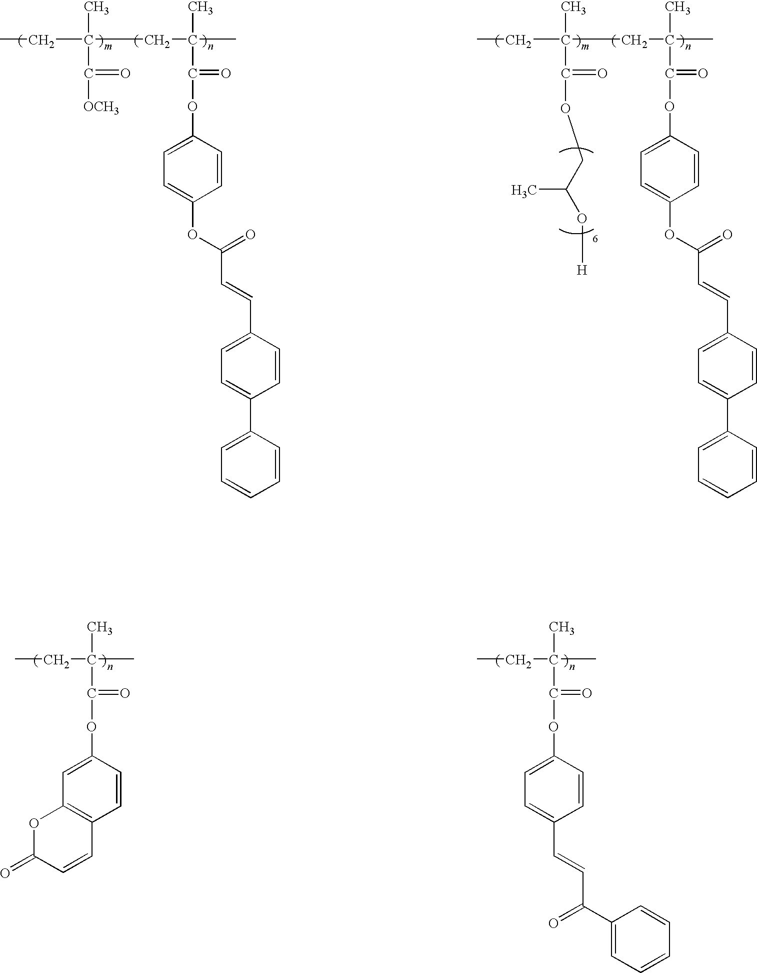

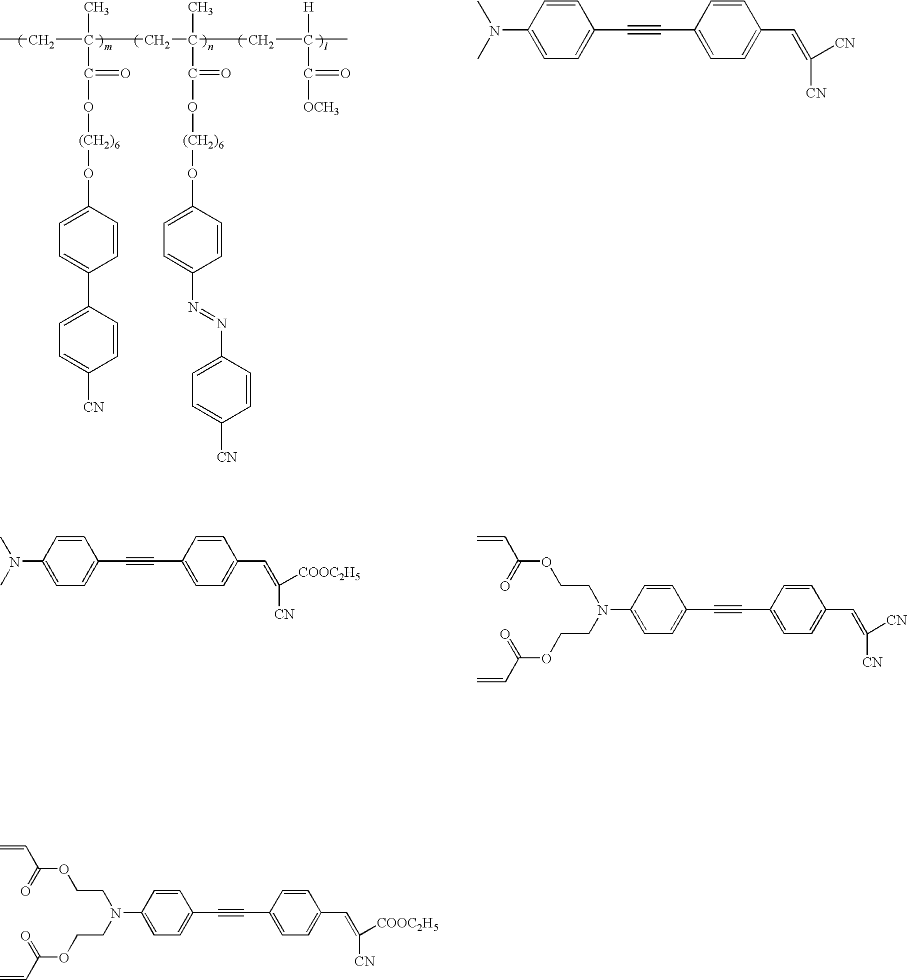

The commercially available compounds may be used in the invention as a photoreactive compound. Examples of those include azobenzene (manufactured by Aldrich), 4-nitro azobenzene (manufactured by Aldrich), Disperse Red 1 (manufactured by Aldrich), Disperse Orange 3 (manufactured by Aldrich) and Sudan 1 (manufactured by Aldrich).

Examples of the commercially available dichroic dye, which can be used in the invention, include “G-202”, “G-205”, “G-206”, “G-207”, “G-232”, “G-239”, “G-241”, “G-254”, “G-256” and “G-289” (each manufactured by Nippon Kanko-Shikiso Kenkyusyo).

### [Non-Liquid Crystalline Polymer]

The non-liquid crystalline polymer which can be used in the invention is not particularly restricted. Polymers generally used as film substrate are preferred. Preferred examples of the non-liquid crystalline polymer include polyacrylates such as polymethylacrylate, polymethacrylates such as polymethylmethacrylate, polyvinylalcohol based polymers such as “Poval” (trade name, manufactured by Kuraray Co., Ltd.), polycarbonate based polymers, polysulfone based polymers, cellulose based polymers such as triacetyl cellulose (trade name “FujiTac” manufactured by Fuji Film, polyolefin based polymers such as “ZEONEX” (trade name, manufactured by ZEON CORPORATION) and “ARTON” (trade name, manufactured by JRMA) and copolymers thereof. Among those, polyacrylates, polymethacrylates and cellulose based polymers are more preferred.

The non-liquid crystal polymer may be subjected to monoaxially or biaxially stretching.

A preferred amount of the photoreactive compound is determined depending on the application use or the like and, generally, it is preferably from 1 to 50 weight parts and, more preferably, from 5 to 30 weight parts with respect to the weight of the non-liquid crystalline polymer. For example, in a case of producing the polymer film according to a solvent cast method as described below, dopes are prepared; and the amounts of the photoreactive compound and the non-liquid crystalline compound are controlled upon preparing the dope such that they are within the preferred range described above.

The polymer film may also comprise other materials than the photoreactive compound and the non-liquid crystalline polymer, such as a polymerization initiator, photosensitizer, plasticizer, stabilizer and flame retardant, so long as the induction of the optical anisotropy is not prevented.

Then, the process for producing an optically anisotropic film of the invention will be described in detail.

### [Production of an Optically Anisotropic Film]

At first, a polymer film comprising at least one photoreactive compound and at least one non-liquid crystalline polymer is prepared. The polymer film may be prepared according to a melting film formation or a solution film formation, and is preferably produced according to a solution film formation. For example, it can be produced with a dope, prepared by dissolving the photoreactive compound and the non-liquid crystalline polymer in a solvent, according to a solvent-cast film formation. A common solvent casting method is described in the specification of U.S. Pat. No. 2,336,310, JPB No. 45-4554 (the term “JPB” as used herein means an “examined published Japanese patent application (Tokkyo Koukoku)”). The dope is cast on a drum or a band, and a film is formed by evaporating the solvent. The dope to be cast is preferably controlled for the concentration such that the solid content is from 10 to 40% by weight. The solid content is, more preferably, from 18 to 35% by weight. The dope may also be cast into two or more layers. The surface of the drum or the band is preferably mirror-finished. Peeled off from the drum or the band, a polymer film is obtained. The solvent used for the preparation of the dope is, preferably, a solvent in which both the photoreactive compound and the non-liquid crystalline polymer can be dissolved. The peeling step may optionally be conducted after the light irradiation step described hereinafter.

Alternatively, the polymer film can be prepared by pouring the dope into a space forming on a substrate with spacers surrounding the space, and drying the solvent. The substrate may be selected from glass substrates, Teflon plates (Teflon: registered trademark) and various kinds of polymer films. Further, the polymer film may also be produced by applying a dope to a surface of an appropriate substrate and then drying the same. The applying may be carried out according to a known coating method such as a curtain coating method, an extrusion coating method, a roll coating method, a spin coating method, a dip coating method, a bar coating method, a spray coating method, a slide coating method, a printing coating method. Then, the polymer film can be obtained by peeling off from the substrate.

The peeling step may be conducted optionally after the light irradiation step described hereinafter. Or the polymer film can be produced without the peeling step, i.e., the polymer film disposed on the substrate can be used in the invention. Employing the polymer film disposed on the substrate in the invention, the substrate is, preferably, a glass substrate or a polymer film having a light transmittance of 80% or more. In a case of using the polymer film as a substrate, the thickness thereof is, preferably, from 10 to 500 μm, more preferably, from 20 to 200 μm and, most preferably, from 35 to 110 μm.

### [Stretching]

The polymer film obtained as described above may optionally be applied with a monoaxial or biaxial stretching under a stress. The stretching may be carried out according to a heat stretching method, a moisture controlled stretching method, or a heat stretching method under moisture control, and the heat stretching method or the heat stretching method under moisture control is preferred. Further, the tenter stretching is used preferably and the difference for the tenter clip speed, detaching timing or the like between right and left is preferably as small as possible for controlling the slow axis at a high accuracy. The stretching ratio is, preferably, from 1.01 to 10 and, more preferably, from 1.03 to 3.

### [Light Irradiation]

Next, the polymer film, which may be disposed on the substrate, is irradiated with a light to induce the anisotropy in the refractive index, and an optically anisotropic film, whose optical anisotropy is adjusted within a predetermined range, can be obtained. If necessary, the light irradiation may be applied to the polymer film while the stretching being applied to the polymer film.

According to the invention, the light irradiation is an operation for initiating photoreaction of the photoreactive compound. The preferred wavelength of the light varies depending on the types of the photoreactive compound and is not particularly restricted so long as this is the wavelength necessary for the photoreaction. The peak wavelength of the light used for the light irradiation is, preferably, from 200 nm to 700 nm and it is, more preferably, an ultraviolet light with the peak wavelength of the light of 400 nm or less.

The light source used for light irradiation can include light sources used usually, for example, lamps such as tungsten lamp, halogen lamp, xenon lamp, xenon flash lump, mercury lamp, mercury xenon lamp, and carbon arc lamp; various kinds of lasers such as semiconductor laser, helium neon laser, argon ion laser, helium cadmium laser, and YAG laser; light emission diodes and cathode ray tubes.

In the light irradiation step, the polymer may be irradiated with either a non-polarized light or a polarized light, is preferably irradiated with a polarized light, and more preferably with a linearly polarized light. As the means for obtaining the linearly polarized light, a method of using a polarizing plate (for example, iodine polarizing plate, dichroic dye polarizing plate and wire grid polarizing plate), a method of using a prism device (for example, Glan-Thomson prism) or a reflection type polarizer utilizing Brewster's angle, or a method of using a light emitted from a laser light source having polarization can be adopted. Further, the polymer film may be selectively irradiated with only the light at a necessary wavelength which can be obtained by using a filter or a wavelength conversion device.

The polymer film may be irradiated with a light from either the upper surface or the rear face in either the normal direction or the oblique direction. The preferred incident angle of the light varies depending on the types of the photoreactive compound, and, in general, it is preferably from 0 to 80°, more preferably from 40 to 80°, and much more preferably from 50 to 70° with respect to the surface of the polymer film.

In a case where patterning of the optically anisotropic film is necessary, the polymer film may be irradiated with a light through a photomask at one or more times necessary for patterning, or irradiated with a light by layer scanning to be written a pattern therein.

The optically anisotropic film of the invention can be used for various applications. For example, it can be used as an optical compensation film contributing to the improvement of the view angle characteristic of a liquid crystal display device.

### [Optical Compensation Film]

The optically anisotropic film of the invention can be employed alone in various image devices as an optical compensation film. The optical characteristics of the optically anisotropic film can be adjusted within the predetermined range, which is necessary for optically compensating, by selecting the stretching factor, the light irradiation amount.

Further, the optically anisotropic film of the invention may have other layer(s) thereon, if necessary. For example, the optical anisotropic film may also have an optically anisotropic layer thereon formed of a liquid crystal composition comprising at least one liquid crystalline compound. The thickness of the optically anisotropic layer is, preferably, from 0.1 to 20 μm and, more preferably, from 0.5 to 10 μm.

For the formation of the optically anisotropic layer, either a rod-like liquid crystalline compound or a disk-shaped liquid crystalline compound may be used. A mixture of two or more kinds of rod-like liquid crystalline compound, two or more kinds of disk-shaped liquid crystalline compound, or a rod-like liquid crystalline compound and a disk-shaped liquid crystalline compound may be used. It is preferably formed by using a rod-like liquid crystalline compound or a disk-shaped liquid crystalline compound having a reactive group since the variations in properties of the layer depending on the temperature or the humidity can be reduced. In the case of employing the mixture, it is more preferred that at least one of them is a liquid crystalline compound having two or more reaction groups in one molecule. The liquid crystalline compound may be a mixture of two or more of compounds, in which at least one of them preferably has two or more reactive groups. Further, the liquid crystalline composition may also comprise an alignment controller, polymerization initiator, sensitizer, crosslinker or the like in addition to at least one liquid crystalline compound.

Further, when the optically anisotropic layer is formed, an alignment layer may be employed. The alignment layer may be formed on the optically anisotropic film. Common horizontal-alignment layers or vertical-alignment layers can be used as an alignment layer for forming the optically anisotropic layer. The alignment layers may be formed by rubbing surfaces of polyvinyl alcohol or polyimide films.

The polymerization of the liquid crystalline composition may be carried out according to various known polymerization methods using heat or electromagnetic waves, and it is preferred that it is carried out according to a radical polymerization method under the irradiation of ultraviolet light using a photopolymerization initiator. In a case where the polymerizable group is an epoxy group, it is also preferred that the polymerization of the liquid crystalline composition is carried out according to a method employing diamines for heat crosslinking.

The optically anisotropic film of the invention can be integrated with a polarizing film and incorporated as a member of a polarizing plate in an image display apparatus.

### [Polarizing Plate]

An embodiment of a polarizing plate according to the invention comprises a polarizing film and a pair of protective films sandwiching the polarizing film in which at least one of the pair of protective films is an optically anisotropic film of the invention. Examples of the polarizing film include iodine polarizing films, dye polarizing films using a dichroic dye, and polyene polarizing films. The iodine polarizing films and the dye polarizing films are produced usually by using polyvinyl alcohol films. The type of the protective film to be used is not particularly restricted, and cellulose esters such as cellulose acetate, cellulose acetate butyrate and cellulose propionate, polycarbonate, polyolefin, polystyrene, and polyester can be used. Usually, the transparent protective film is preferably supplied in a roll form, and continuously bonded to a long polarizing film so that the longitudinal directions thereof are aligned. The alignment axis (slow axis) of the protective film may be in any direction. Further, the angle for the slow axis (alignment axis) of the protective film and that of the absorption axis (stretching axis) of the polarizing film are also not restricted particularly but can be set properly in accordance with the purpose of the polarizing plate.

The polarizing film and the protective film may be bonded to each other with an aqueous adhesive. The adhesive solvent included in the aqueous adhesive is dried by diffusion in the protective film. As the moisture permeability of the protective film is higher, the drying is promoted more to improve the productivity. However, the moisture permeability of the protective film is so high that the moisture penetrates into the polarizing film under high humidity, and that the polarizing performance is lowered. The moisture permeability of the optically anisotropic film of the invention varies, for example, depending on the thickness, the free volume, or hydrophilic or hydrophobic property of the optically anisotropic film (and an optically anisotropic layer formed of a liquid crystalline composition). The moisture permeability of the protective film of the polarizing plate is, preferably, within a range from 100 to 1,000 (g/m²)/24 hrs and, more preferably, within a range from 300 to 700 (g/m²)/24 hrs.

In the invention, an optically anisotropic film of the invention may be used as one of the protective films with an aim of reducing the thickness or the like. In a case where the optically anisotropic film has the optically anisotropic layer thereon, it is preferred to bond the surface of the polarizing film and the rear face of the optically anisotropic film (surface on the side not formed with the optically anisotropic layer) to each other. In a view point of preventing displacement between the optical axes or preventing intrusion of obstacles such as dusts, it is preferred that the optically anisotropic film of the invention and the polarizing film are bonded firmly to each other. For bonding firmly to each other, a transparent adhesive layer, comprising an adhesive agent, may be disposed between them. The type of the adhesive agent, which can be used in the invention, is not particularly limited to, and those not requiring a high temperature process upon curing or drying for forming the adhesive layer are preferred and those not requiring long time curing treatment or drying time are preferred with a view point of preventing the change of the optical characteristic of constituent members. With the view point described above, a hydrophilic polymer type adhesive or pressure sensitive adhesive layer is used preferably.

The optically anisotropic film and the polarizing plate employing the film of the invention are suitable for use in image display devices, particularly, liquid crystal display devices comprising a liquid crystal cell. Use of them to image display devices, particularly, to liquid crystal display devices contributes to the improvement of display characteristic such as view angle characteristic.

A process for producing a polarizing film according to the invention will be described in detail.

### [Polarizing Film]

The invention relates to a polarizing film produced by irradiating a polymer film, comprising at least one photoreactive compound having absorption in a wavelength region of from 400 nm to 800 nm and at least one non-liquid crystalline polymer, with a polarized light, thereby inducing the polarization property. It is not necessary that the photoreaction compound has the absorption peak at a wavelength region of 400 nm to 800 nm but it may suffice that the photoreaction compound has an absorption in a wavelength region of from 400 nm to 800 nm. When the polymer film was irradiated with a linearly polarized light, the photoreaction of the photoreactive compound is carried out thereby to induce the polarization property. As a result, the polarization property of the polymer can be adjusted within a predetermined range.

Various kinds of materials used for the manufacture of the polarizing film of the invention will be described in detail.

For the photoreactive compound used for the polarizing film, photoreactive compounds described above having absorption in the wavelength region of 400 nm to 800 nm are used. Specifically, azobenzene compounds and tolan compounds can be used preferably. For example, commercially available compounds such as azobenzene (manufactured by ALDRICH), 4-nitro azobenzene (manufactured by ALDRICH), Disperse Red 1 (manufactured by ALDRICH), Disperse Orange 3 (manufactured by ALDRICH), and Sudan 1 (manufactured by ALDRICH CORP.), or commercially available dichroic dyes such as “G-202”, “G-205”, “G-206”, “G-207”, “G-232”, “G-239”, “G-241”, “G-254”, “G-256” and “G-289” (each manufactured by Nippon Kanko-Shikiso Kenkyusyo) or the like can be used.

Examples of the non-liquid crystalline polymers which can be used for producing the polarizing film are same as those described above.

Then, a process for producing the polarizing film of the invention will be described in detail.

### [Preparation of Polarizing Film]

At first, a polymer film comprising at least one photoreactive compound having absorption in a wavelength region of from 400 nm to 800 nm and at least one non-liquid crystalline polymer is prepared. Examples of the film formation which can be employed for producing the polymer film are same as those described above.

### [Irradiation of Linearly Polarized Light]

Next, the polymer film, which may be disposed on a substrate, is irradiated with a linearly polarized light thereby to induce a polarization property. And a polarizing film, whose polarization property is adjusted within a predetermined range, can be obtained.

According to the invention, the irradiation of the linearly polarized light is an operation for initiating the photoreaction of the photoreactive compound. The preferred wavelength of the light varies depending on the type of the photoreactive compound to be used and is not particularly restricted so long as it is necessary for the photoreaction. Preferably, the peak wavelength of the light used for the light irradiation is from 200 nm to 700 nm and, more preferably, it is an ultraviolet light with the peak wavelength of the light being 400 nm or less. For the light source used for the polarized light irradiation and the means for obtaining the linear polarization, the foregoing description can be applied.

The polymer film may be irradiated with a light from the upper surface or the rear face in the normal direction or the oblique direction. It is preferred that the polymer film is irradiated with a light in the normal direction.

In a case where patterning of the polarizing film is necessary, the polymer film may be irradiated with a light through a photomask at one or more times necessary for patterning, or irradiated with a light by layer scanning to be written a pattern therein.

The polarizing film of the invention can be employed for various applications. For example, the polarizing film of the invention can be employed alone in various kinds of image displaying devices as a polarizing film. Further, the polarizing film of the invention can be used also as a color filter exhibiting a polarization property.

### EXAMPLES

The invention will be further specifically described below with reference to the following Examples. Materials, reagents, amounts and proportions thereof, operations, and the like as shown in the following Examples can be properly changed so far as the gist of the invention is not deviated. Accordingly, it should not be construed that the scope of the invention is limited to the following specific examples.

### Example 1

The following dope solution 1 was prepared, filtered through a microfilter (DISMIC-13 PTFE 0.45MM: manufactured by ADVANTEC Co.), and poured into a square space of 3 cm×3 cm formed on a glass substrate with a Teflon tape of 180 μm thickness. The solvent was evaporated at a room temperature for about 12 hours, to prepare a polymer film of 33 μm thickness.

Dope solution 1

| | | |
|---|---|---|
| Polymethylmethacrylate (manufactured by | 100 | mg |
| ALDRICH) | | |
| Disperse Red 1 (manufactured by ALDRICH) | 10 | mg |
| Chloroform | 1 | mL |

Then, the polymer film, disposed on the glass substrate, was irradiated with a linearly polarized light, obtained by polarizing a light emitted from a halogen lamp through a polarizing plate, in the normal direction thereto at a light intensity of 100 mW/cm² (365 nm) for 60 min. An optically anisotropic film, disposed on the glass substrate, whose optical anisotropy was induced, was obtained. The retardation value (Re value) of the obtained film was measured together with the glass substrate according to a Senarmon method, and it was found that a value of Re (650 nm) was 78 nm.

### Example 2

An optically anisotropic film, disposed a glass substrate, was produced in the same manner as Example 1, except for changing the irradiation time of a linearly polarized light irradiation in Example 1. The retardation value (Re value) for each of the obtained polymer films was measured together with the glass substrate by using KOBRA 31 PRN (manufactured by Oji Scientific Instruments Co.), to confirm the induction of retardation with a slow axis along with the direction perpendicular to the direction of the linearly polarized light. The dependence of the induction of retardation on the irradiation time is shown below. As a result, it was found that the retardation value in the normal direction could be controlled by selecting the irradiation time.

| Irradiation time | Re (629 nm) |
|---|---|
| 3 min | 16.3 |
| 5 min | 32.5 |
| 10 min | 37.9 |
| 20 min | 59.6 |
| 30 min | 65.0 |

### Example 3

A polymer film of 33 μm thickness was prepared in the same manner as in Example 1. Then, the polymer film, disposed on the glass substrate, was irradiated with a linearly polarized light, obtained by polarizing a light emitted from a halogen lamp through a polarizing plate, in the 45 degree oblique direction relative to the polymer film at a light intensity of 100 mW/cm² (365 nm) for 30 min. A retardation value (Re value) was measured by incidence of a light at a wavelength of 629 nm to the obtained polymer film by using KOBRA WR (manufactured by Oji Scientific Instrument Co.) in the direction rotated at each angle of from −45° to +45° on every 15° interval relative to the normal direction to the film with using the slow axis in the plane (judged by KOBRA WR) as a incline axis (rotation axis), and the angle dependence thereof was examined. The result is shown below. It was found from the result that retardation could be controlled in a three dimensional manner.

| Incident angle | Re (629 nm) |
|---|---|
| −45° | 18.9 |
| −30° | 18.6 |
| −15° | 18.2 |
| −0° | 15.6 |
| −15° | 13.0 |
| −30° | 10.4 |
| −45° | 9.7 |

### Example 4

The following dope solution 4 was prepared, filtered through a microfilter (DISMIC-13 PTFE 0.45MM: manufactured by ADVANTEC Co.), and poured into a square space of 3 cm×3 cm formed on a glass substrate with a Teflon tape of 180 μm. The solvent was evaporated at a room temperature for about 12 hours, and a polymer film of 30 μm thickness was obtained.

Dope solution 4

| | | |
|---|---|---|
| TAC cotton | 200 | mg |
| Disperse red 1 (manufactured by ALDRICH) | 20 | mg |
| Chloroform | 2 | mL |

Then, the obtained polymer film was irradiated with a linearly polarized light, obtained by polarizing a light emitted from a halogen lamp through a polarizing plate, in the normal direction thereto at a light intensity of 100 mW/cm² (365 nm) for 60 min. Peeled off from the glass substrate, an optically anisotropic film, whose optical anisotropy was adjusted within a predetermined range, was obtained.

The retardation value (Re value) of the obtained film was measured by using KOBRA 31 PRN (manufactured by Oji Scientific Instruments Co.), and it was found that the Re (650 nm) value was 27 nm with a slow axis along with the direction perpendicular to the direction of the linearly polarized light.

### Example 5

The following dope solution 5 was prepared, filtered through a microfilter (DISMIC-13 PTFE 0.45MM: manufactured by ADVANTEC Co.), and poured into a square space of 3 cm×3 cm formed on a glass substrate with a Teflon tape of 180 μm. The solvent was evaporated at a room temperature for about 12 hours, and a polymer film of 31 μm thickness was obtained.

Dope solution 5

| | | |
|---|---|---|
| Polymethylmethacrylate (manufactured by ALDRICH) | 100 | mg |
| Liquid crystal cinnamic acid derivative 5-1 described below | 10 | mg |
| Chloroform | 2 | mL |

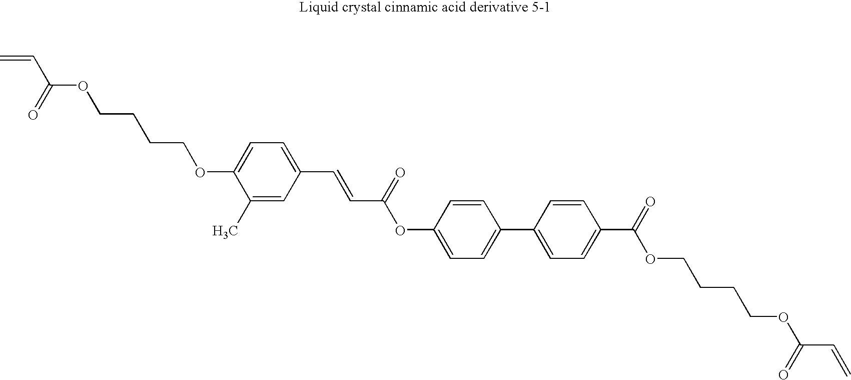

Then, the obtained polymer film was irradiated with a linearly polarized light, obtained by polarizing a light emitted from a ultraviolet irradiation apparatus through a polarizing plate, in the normal direction thereto at a light intensity of 100 mW/cm² (365 nm) for 30 min. And an optically anisotropic film whose optical anisotropy was induced, was obtained.

The retardation value (Re value) of the obtained film was measured by incidence of a light at a wavelength of 548 nm in the normal direction to the film in KOBRA 31 PRN (manufactured by Oji Scientific Instruments Co.) to obtain the Re value (548 nm) of 12 nm with a slow axis along with the direction perpendicular to the direction of the irradiated linearly polarized light.

It is to be noted that the liquid crystal cinnamic acid derivative 5-1 can be synthesized by using 4-(4-acryloyloxy)butyloxy-3-methyl cinnamic acid synthesized according to a method described in JPA No. 2002-97170 and 4-acryloyloxybutyl 4′-hydroxybiphenyl-4′-carboxylate synthesized according to a method described in JPA No. 2003-327561 and condensing them according to a dicyclohexyl carbodiimide method.

### Example 6

The following dope solution 6 was prepared, filtered through a microfilter (DISMIC-13 PTFE 0.45MM: manufactured by ADVANTEC Co.), and applied to a surface of a glass substrate by spin coating (3500 rpm, 20 s) to prepare a polymer film of 5.6 μm thickness.

Dope solution 6

| | | |
|---|---|---|
| Polymethylmethacrylate (manufactured by ALDRICH) | 100 | mg |
| Liquid crystal cinnamic acid derivative 6-1 described below | 50 | mg |
| Chloroform | 2 | mL |

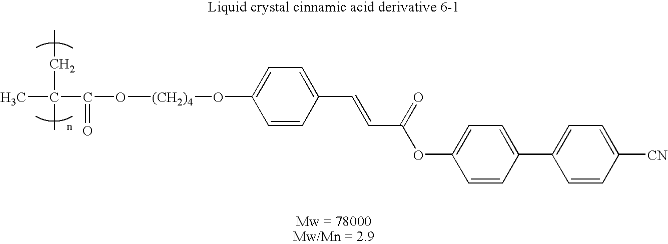

Then, the obtained polymer film was irradiated with a linearly polarized light, obtained by polarizing a light emitted from a light emitted from a ultraviolet irradiation apparatus through a polarizing plate, in the normal direction thereto at a light intensity of 100 mW/cm² (365 nm) for 15 min. And an optically anisotropic film whose optical anisotropy was induced, was obtained.

The retardation value (Re value) of the obtained film was measured by incidence of a light at a wavelength of 548 nm in the normal direction to the film in KOBRA 31 PRN (manufactured by Oji Scientific Instruments Co.), to obtain the Re value (548 nm) 7.2 nm with a slow axis along with the direction perpendicular to the direction of the irradiated linearly polarized light.

It is to be noted that the liquid crystal cinnamic acid derivative 6-1 can be synthesized by using 4-(4-methacryloyloxy)butyloxy cinnamic acid synthesized according to a method as described in JPA No. 2002-97170 and 4-hydroxy-4′-cyanobiphenyl and condensing them by a dicyclohexyl carbodiimide method into 4-(4′-methacryloyloxy) butyloxy cinnamic acid 4′-cyanobiphenyl, followed by polymerization according to an AIBN method.

### Example 7

The following dope solution 7 was prepared, filtered through a microfilter (DISMIC-13 PTFE 0.45MM: manufactured by ADVANTEC Co.), and applied to a surface of a glass substrate by spin coating (3500 rpm, 20 s) to prepare a polymer film of 4.6 pin thickness.

Then, the obtained polymer film was irradiated with a linearly polarized light, obtained by polarizing a light emitted from a ultraviolet irradiation apparatus through a polarizing plate in the normal direction thereto at a light intensity of 100 mW/cm² (365 nm) for 15 min. And an optically anisotropic film whose optical anisotropy was induced, was obtained.

The retardation value (Re value) of the obtained film was measured by incident of a light at a wavelength of 548 nm in the normal direction to the film in KOBRA 31 PRN (manufactured by Oji Scientific Instruments Co.), to obtain the Re value (548 nm) 11.8 nm with a slow axis along with the direction perpendicular to the direction of the irradiated linearly polarized light.

Dope solution 7

| | | |
|---|---|---|
| Polymethylmethacrylate (manufactured by ALDRICH) | 100 | mg |
| Liquid crystal cinnamic acid derivative 7-1 described below | 100 | mg |
| Tetrahydrofuran | 2 | mL |

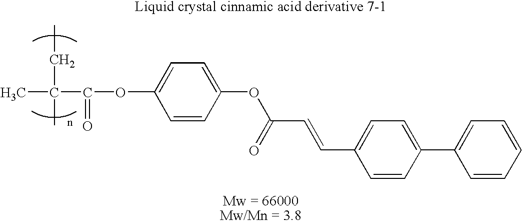

### Example 8

The following dope solution 8 was prepared, filtered through a microfilter (DISMIC-13 PTFE 0.45MM: manufactured by ADVANTEC Co.), and applied to a surface of a glass substrate by spin coating (3500 rpm, 20 s) to prepare a polymer film of 5.2 μm thickness.

Then, the obtained polymer film was irradiated with a linearly polarized light, obtained by polarizing a light emitted from a ultraviolet irradiation apparatus through a polarizing plate in the normal direction thereto at a light intensity of 100 mW/cm² (365 nm) for 15 min. And an optically anisotropic film whose optical anisotropy was induced, was obtained.

The retardation value (Re value) of the obtained film was measured by incidence of a light at a wavelength of 548 nm in the normal direction to the film in KOBRA 31 PRN (manufactured by Oji Scientific Instruments Co.), to obtain the Re value (548 nm) 8.0 nm with a slow axis along with the direction perpendicular to the direction of the irradiated linearly polarized light.

Dope solution 8

| | | |
|---|---|---|
| Polymethylmethacrylate (manufactured by ALDRICH) | 100 | mg |
| Liquid crystal cinnamic acid derivative 8-1 described below | 50 | mg |
| Tetrahydrofuran | 2 | mL |

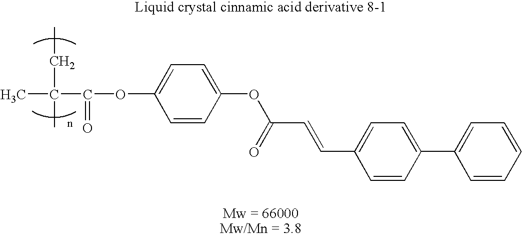

### Example 9

A dope solution prepared in the same manner as in Example 4 was poured into a square space of 6 cm×3 cm formed on a glass substrate with a Teflon tape of 180 μm thickness. The solvent was evaporated at a room temperature for about 12 hours. And a polymer film of 32 μm thickness was obtained. The obtained polymer film was peeled off, and monoaxially stretched at a 1.1-fold under a circumstance having a humidity of 60% and a temperature of 60° C. by using a stretcher (manufactured by Ono Seigyo Keisoku Co., Ltd).

Then, the polymer film was irradiated with a linearly polarized light, obtained by polarizing a light emitted from a halogen lamp through a polarizing plate, in the normal direction thereto at a light intensity of 100 mW/cm² (365 nm) for 60 min. An optically anisotropic film, whose optical anisotropy was induced, was obtained.

The retardation value (Re value) of the obtained film was measured by using KOBRA 31PRN (manufactured by Oji Scientific Instruments Co.), provided that a slow axis was perpendicular to the direction of the irradiated linearly polarized. Then, it was found that the Re value (650 nm) was 29 nm with a slow axis along with direction parallel to the stretching direction of the polymer film.

### Example 10

A dope solution prepared in the same manner as in Example 4 was poured into a square space of 6 cm×3 cm formed on a glass substrate with a Teflon tape of 180 μm thickness. The solvent was evaporated at a room temperature for about 12 hours. And a polymer film of 32 μm thickness was obtained. The obtained polymer film was peeled off, and monoaxially stretched at a 1.1-fold under a circumstance having a humidity of 60% and a temperature of 60° C. by using a stretcher (manufactured by Ono Seigyo Keisoku Co., Ltd.).

Then, the polymer film was irradiated with a linearly polarized light, obtained by polarizing a light emitted from a halogen lamp through a polarizing plate, in the normal direction thereto at a light intensity of 100 mW/cm² (365 nm) for 60 min. An optically anisotropic film, whose optical anisotropy was induced, was obtained.

The retardation value (Re value) of the obtained polymer film was measured by using KOBRA 31PRN (manufactured by Oji Scientific Instruments Co.), provided that a slow axis was perpendicular to the direction of the irradiated linearly polarized light. The, it was found that the Re value (650 nm) was 26 nm with a slow axis along with the direction perpendicular to the stretching direction of the polymer film.

### Example 11

A coating fluid for alignment layer AL-11 described below was applied to a surface of the polymer film prepared in Example described above by a #14 wire bar coater, dried and rubbed in a direction parallel to the direction of the irradiated linear polarized light. Then, a coating fluid for liquid crystal optically anisotropic layer LC-11 described below was applied to a rubbed surface of the alignment layer by spin coating (2000 rpm, 20 s), hardened by UV-ray irradiation (254 nm, 50 mW/cm², 15 sec) to form an optically anisotropic layer of 2.2 μm thickness.

Coating fluid for alignment layer AL-11
Composition for coating fluid for alignment layer (%)

| | |
|---|---|
| Modified polyvinyl alcohol AL-1-1 | 4.01 |
| Water | 72.89 |
| Methanol | 22.83 |
| Glutaric aldehyde (crosslinker) | 0.20 |
| Citric acid | 0.008 |
| Monoethyl citrate | 0.029 |
| Diethyl citrate | 0.027 |
| Triethyl citrate | 0.006 |

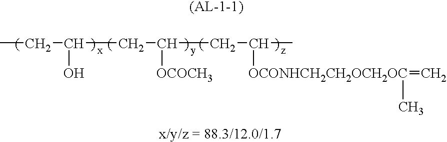

Modified polyvinyl alcohol described in JPA No. 9-152509 was used.

Coating fluid for liquid crystal optically anisotropic layer LC-11
Composition for coating fluid for liquid crystal optically anisotropic
layer (%)

| | |
|---|---|
| Liquid crystal compound LC-11-1 | 20.0 |
| Ethylene oxide-modofied trimethylol propane triacrylate | 0.1 |
| (manufactured by Osaka Organic Chemical Industry Ltd.) | |
| Irgacure 907 (0.3 wt %) | |
| (Chiba Specialty Chemicals Co., Ltd.) | |
| Kayacure DETX-S | 0.01 |
| (manufactured by Nippon Kayaku Co., Ltd.) | |
| Methyl ethyl ketone | 79.86 |

Liquid crystal compound LC-11-1

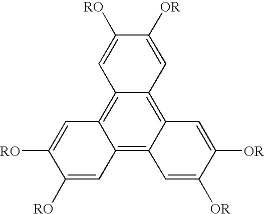

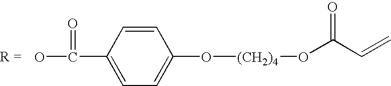

A liquid crystal compound LC-11-1 was synthesized according to a method as described in the Journal of Fuji Photo Film Research Report, Vol. 42, pp 48 (1997) or “Light-Controlling Macromolecules/Supermolecules in Next-Generation”, edited by “The Society of Polymer Science, Japan” (2000).

### Example 12

An optically anisotropic layer of 2.2 μm film thickness was formed on the polymer film manufactured in Example 7 in the same manner as in Example 11 except for rubbing in the direction perpendicular to the direction of the irradiated linearly polarized light.

### Example 13

### Wavelength Dependency of Retardation in the Normal Direction

Retardation values (Re values) of the polymer film obtained in Examples 11 and 12 were measured by using KOBRA 31 PRN (manufactured by Oji Scientific Instruments Co.). The results are shown below.

| | Re(499 nm) | Re(548 nm) | Re(623 nm) | Re(749 nm) |
|---|---|---|---|---|
| Example 11: | 22.2 | 19.5 | 18.0 | 16.5 |
| Example 12: | 43.1 | 38.9 | 36.9 | 34.8 |

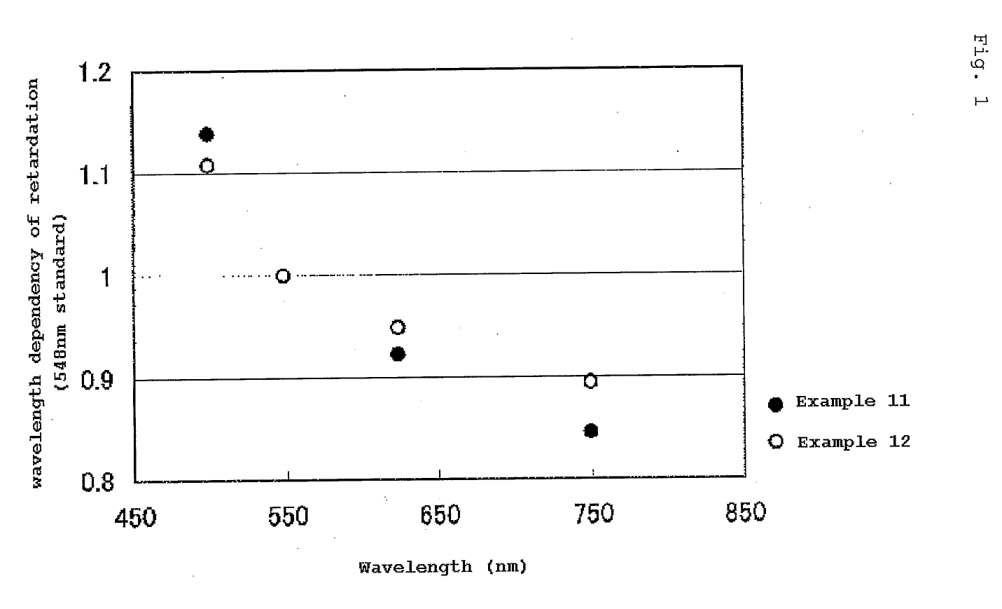

FIG. 1 is a graph showing the wavelength dependency of retardation described above. In the graph, the retardation values in each wavelength were normalized based on the retardation of 548 nm and plotted. From the graph of FIG. 1, it was found that the wavelength dependency of the retardation in the normal direction could be controlled easily according to the method.

### Example 14

### Preparation of a Patterned Optically Anisotropic Film

A dope 14 described below was prepared, filtered through a microfilter (DISMIC-13, PTFE 0.45 MM: ADVANTEC Co.) and applied to a surface of a glass substrate by spin coating (3500 rpm, 20 s). And a polymer film of 2.6 μm film thickness was obtained.

Dope 14

| | | |
|---|---|---|
| Azobenzene derivative 14-1 described below | 200 | mg |
| Chloroform | 1 | mL |

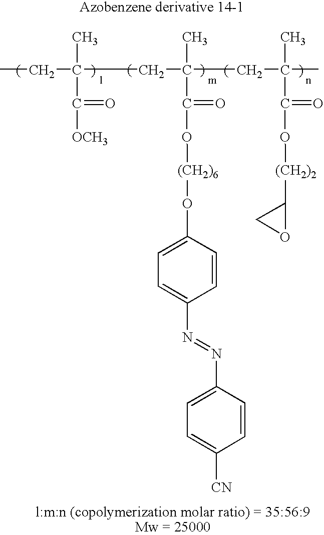

Then, the polymer film was irradiated with a linearly polarized light, obtained by polarizing a light emitted from a ultraviolet irradiation apparatus through a polarizing plate, in the normal direction thereto at a light intensity of 100 mW/cm² (365 nm) for 15 min. An optically anisotropic film, whose optical anisotropy was induced, was obtained.

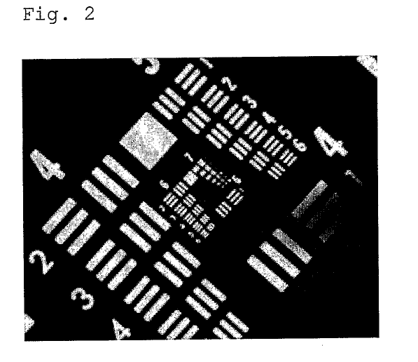

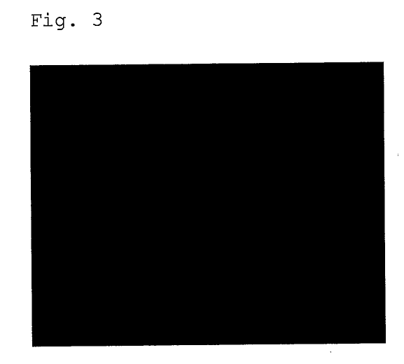

The obtained film was observed under a polarization microscope, to confirm that a pattern was formed. Results of observation are shown for the diagonal positions in FIG. 2 and for extinction position in FIG. 3.

### Example 15

### Preparation of a patterned Optical Anisotropic Polymer Film 2

A dope 15 described below was prepared, filtered through a micro filter (DISMIC-13, PTFE 0.45 MM: ADVANTEC Co.) and applied to a surface of a glass substrate by spin coating (3500 rpm, 20 s). A polymer film of 2 μm thickness was obtained.

Dope solution 15

| | | |
|---|---|---|
| Polymethylmethacrylate (manufactured by | 100 | mg |
| ALDRICH) | | |
| Dichroic pigment G-254 | 10 | mg |
| (manufactured by Nippon Kanko-Shikiso | | |
| Kenkyusyo) | | |
| Chloroform | 1 | mL |

Then, the polymer film was irradiated with a linearly polarized light, obtained by polarizing a light emitted from a ultraviolet irradiation apparatus through a polarizing plate, in the normal direction thereto at a light intensity of 100 mW/cm² (365 nm) for 15 min. An optically anisotropic film, whose optical anisotropy was induced, was obtained.

### Example 16

### Preparation of a Polarizing Film 1

A polymer film, formed on a glass substrate in the same manner as in Example, was irradiated with a linearly polarized light, obtained by polarizing a UV light emitted from a UV irradiation apparatus (UL-250, manufactured by HOYA-SCOTT) through a polarizing plate, in the normal direction thereto at a light intensity of 100 mW/cm² (365 nm) for 900 sec. Then, a polarizing film disposed on a glass plate, was obtained.

A polarized transmission spectrum of the obtained polarizing film was measured in the manner that a polarizing plate was inserted in an optical path of a spectrophotometer (UV-2400 PC, manufactured by Shimadzu), and it was confirmed that the transmission light exhibited a dichroic ratio of 2.7 (580 nm).

### Example 17

### Preparation of a Polarizing Film 2

A following dope 17 was prepared, filtered through a microfilter (DISMIC-13 PTFE 0.45 MM: manufactured by ADVANTEC Co.), and applied to a surface of a glass substrate by spin coating (3500 rpm, 20 s). A polymer film of 2 μm thickness was obtained. A tolan derivative 17-1 used as a photoreactive compound is a dye having an absorption maximum at a wavelength of 469 nm (in chloroform).

Dope solution 17

| | | |
|---|---|---|
| polymethylmethacrylate (manufactured by ALDRICH) | 100 | mg |
| Tolan derivative 17-1 described below | 10 | mg |
| Chloroform | 1 | mL |

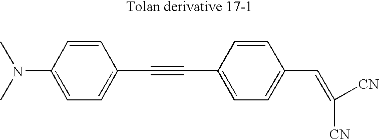

The obtained film, disposed on a glass plate, was irradiated with a linearly polarized light, obtained by polarizing a UV light emitted from a UV irradiation apparatus (UL-250, manufactured by HOYA-SCOTT) through a polarizing plate, in the normal direction thereto at a light intensity of 100 mW/cm² (365 nm) for 900 sec. A polarizing film disposed on a glass substrate was obtained.

A polarized transmission spectrum of the obtained polarizing film was measured in the manner that the polarizing plate was inserted in an optical path of a spectrophotometer (UV-2400 PC, manufactured by Shimadzu), and it was confirmed that the transmission light exhibited a dichroic ratio of 34 (440 nm).

### Example 18

### Preparation of a Polarizing Film 3

A following dope 18 was prepared, filtered through a microfilter (DISMIC-13 PTFE 0.45 MM: manufactured by ADVANTEC Co.), and applied to a surface of a glass substrate by spin coating (3500 rpm, 20 s). A polymer film of 2 μm thickness was obtained.

Dope 18

| | | |
|---|---|---|
| polymethylmethacrylate (manufactured by ALDRICH) | 100 | mg |
| Dichroic pigment G-206 (Nippon Kanko-Shikiso Kenkyusyo) | 9 | mg |
| Dichroic pigment G-254 (Nippon Kanko-Shikiso Kenkyusyo) | 3 | mg |
| Chloroform | 1 | mL |

The obtained polymer film, disposed on a glass plate, was irradiated with a linearly polarized light, obtained by polarizing a UV light emitted from a UV irradiation apparatus (UL-250, manufactured by HOYA-SCOTT), in the normal direction thereto at a light intensity of 100 mW/cm² (365 nm) for 900 sec. A polarizing film disposed on the glass substrate was obtained.

A polarization transmission spectrum of the obtained polarizing film was measured in the manner that a polarizing plate was inserted in an optical path of a spectrophotometer (UV-2400 PC, manufactured by Shimadzu), and it was confirmed that the transmission light exhibited a dichroic ratio of 1.5 (440 nm).

### Example 19

### Preparation of a Polarizing Film 4

A following dope 19 was prepared, filtered through a microfilter (DISMIC-13 PTFE 0.45 MM: manufactured by ADVANTEC Co.), and applied to a surface of a glass substrate by spin coating (3500 rpm, 20 s). A polymer film of 2 μm thickness was obtained. The azobenzene derivative 19-1 used as a photoreactive compound is a compound having a maximum absorption at the wavelength of 360 nm (in chloroform).

Dope 19

| | | |
|---|---|---|
| polymethylmethacrylate (manufactured by ALDRICH) | 100 | mg |
| Azobenzene derivative 19-1 described below | 10 | mg |
| Chloroform | 1 | mL |

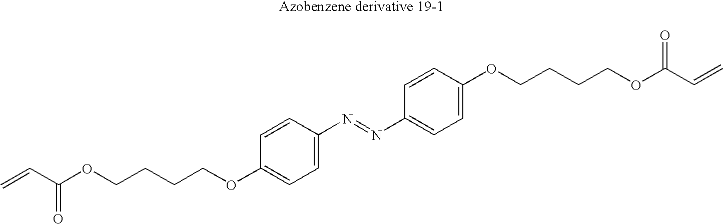

The obtained polymer film, disposed on a glass plate, was irradiated with a linearly polarized light, obtained by polarizing a UV light emitted from a UV irradiation apparatus (UL-250, manufactured by HOYA-SCOTT) through a polarizing plate, in the normal direction thereto at a light intensity of 100 mW/cm² (365 nm) for 900 sec. A polarizing film disposed on the glass substrate was obtained.

A polarization transmission spectrum of the obtained polarizing film was measured in the manner that a polarizing plate was inserted in an optical path of a spectrophotometer (UV-2400 PC, manufactured by Shimadzu), and it was confirmed that the transmission light exhibited a dichroic ratio of 3.5 (440 nm).

### INDUSTRIAL APPLICABILITY

According to the invention, retardation of the polymer film can be adjusted within the predetermined range, and the wavelength dispersion is also controllable. Accordingly, it is possible to provide an optically anisotropic film exhibiting an optical anisotropy optimum to optically compensating liquid crystal cells employing various modes, namely, useful as an optical compensation film. Further, the optically anisotropic film of the invention can be used as a protective film for a polarizing plate and various types of polymer films to be used in various types of image display apparatus, particularly, liquid crystal display devices.

Further, according to the invention, it is possible to provide a polarizing film having fine polarizing pattern formed thereon and a color filter exhibiting a polarizing property.

### CROSS-REFERENCE TO RELATED APPLICATIONS

This application claims benefit of priorities under 35 USC 119 to Japanese Patent Application Nos. 2005-206652 filed Jul. 15, 2005 and 2005-278035 filed Sep. 26, 2005.

1. An optically anisotropic film produced by irradiating a polymer film, comprising at least one photoreactive compound and at least one non-liquid crystalline polymer, with a light, thereby inducing or changing an optical anisotropy of the polymer film.

2. The optically anisotropic film of claim 1, wherein the photoreactive compound has at least one polymerizable group.

3. The optically anisotropic film of claim 1, wherein the photoreactive compound is a liquid crystalline compound.

4. The optically anisotropic film of claim 1, wherein the photoreactive compound is a cinnamic acid derivative or a coumarin derivative.

5. The optically anisotropic film of claim 1, wherein the non-liquid crystalline polymer is selected from the group consisting of polyacrylates, polymethacrylates, polyvinyl alcohols, polycarbonates, polysulfones, cellulose based polymers, polyolefins and copolymers thereof.

6. The optically anisotropic film of claim 1, wherein the polymer film is a monoaxially or biaxially oriented film.

7. The optically anisotropic film of claim 1, further comprising an optically anisotropic layer containing a polymer of a liquid crystalline composition comprising at least one liquid crystalline compound.

8. The optically anisotropic film of claim 1, used as an optical compensation film.

9. A polarizing plate comprising a linear polarizing film and an optically anisotropic film as claimed in claim 1.

10. An image-displaying element comprising an optically anisotropic film as claimed in claim 1.

11. A process for producing an optically anisotropic film comprising irradiating a polymer film, comprising at least one photoreactive compound and at least one non-liquid crystalline polymer, with a light, thereby controlling an optical anisotropy of the polymer film.

12. The process of claim 11, further comprising stretching the polymer film monoaxially or biaxially before the irradiating.

13. The process of claim 11, wherein the irradiating is carried out by irradiating the polymer film with a light coming from a direction inclined by θ° (0<θ) relative to the normal direction of the polymer film.

14. The process of claim 11, wherein the irradiation light is a linearly polarized light.

15. The process of claim 11, wherein the irradiation light is an ultraviolet light.

16. A polarizing film produced by irradiating a polymer film, comprising at least one photoreactive compound having an absorption in a wavelength region of from 400 nm to 800 nm and at least one non-liquid crystalline polymer, with a polarized light, thereby inducing a polarization ability of the polymer film.

17. The polarizing film of claim 16, wherein the photoreactive compound is a dichroic compound.

18. The polarizing film of claim 16, wherein the photoreactive compound is a photodegradable compound.

19. A process for producing a polarizing film comprising irradiating a polymer film, comprising at least one photoreactive compound and at least one non-liquid crystalline polymer, with a linearly polarized light, thereby controlling a polarization ability of the polymer film.

20. A color filter formed of a polarizing film as claimed in claim 16.

21. An image-displaying element comprising a polarizing film as claimed in claim 16.

22. An image-displaying element comprising a polarizing plate as claimed in claim 9.

23. An image-displaying element comprising a color filter as claimed in claim 20.
